(19) United States
(12) Patent Application Publication
(10) Pub. No.: US 2022/0342898 A1
(43) Pub. Date: Oct. 27, 2022

(54) APPARATUS, METHOD AND COMPUTER-READABLE MEDIUM FOR ACCESS

(71) Applicant: MyGnar, Inc., Santa Monica, CA (US)

(72) Inventors: Timothy Feess, Venice, CA (US); Michael Lemmon, Mount Victoria (NZ)

(21) Appl. No.: 17/724,575

(22) Filed: Apr. 20, 2022

Related U.S. Application Data
(60) Provisional application No. 63/178,049, filed on Apr. 22, 2021.

(51) Int. Cl. G06F 16/25

(52) U.S. Cl. CPC G06F 16/256; G06F 16/258

(57) ABSTRACT

Embodiments of the present disclosure provide an apparatus, method and computer-readable medium for virtual access. An exemplary method includes capturing, by a user equipment (UE), a first data, wherein the first data comprises at least one of audio, video, and images. The method further includes transmitting, by the UE, the first data to a second UE, wherein the second UE is a server, and representing, by the second UE, an existence of the first data within a virtual database. The method still further includes accessing, by a third UE, the first data on the second UE, wherein the accessing comprises receiving at least one of the first data, a portion of the first data, a proxy file of the first data, and a low resolution version of the first data based on an application running on the third UE.

### BACKGROUND OF THE INVENTION

### Field of the Invention

Embodiments of the present disclosure relate generally to an apparatus, method and computer-readable medium for access. The embodiments of the present disclosure relate more particularly to an apparatus, method, and computer-readable medium for access and/or virtual access of data.

### Description of Related Art

Cloud computing is shared pools of configurable computer system resources and higher-level services that can be rapidly provisioned with minimal management effort, such as through the internet. Cloud computing relies on the sharing of resources to achieve coherence and economies of scale.

Third-party clouds enable organizations to focus on their core businesses instead of expending resources on computer infrastructure and maintenance. Advocates note that cloud computing allows companies to avoid or minimize up-front IT infrastructure costs. Proponents also claim that cloud computing allows enterprises to get their applications up and running faster, with improved manageability and less maintenance, and that it enables IT teams to more rapidly adjust resources to meet fluctuating and unpredictable demand. Cloud providers typically use a pay as you go model, which can lead to unexpected operating expenses if administrators are not familiarized with cloud-pricing models.

The availability of high-capacity networks, low cost computers and storage devices as well as the widespread adoption of hardware virtualization, service-oriented architecture, and autonomic and utility computing has led to growth in cloud computing.

### BRIEF SUMMARY OF THE INVENTION

In view of the foregoing, it is an object of the present disclosure to provide a method and apparatus for evacuation.

A first exemplary embodiment of the present disclosure provides a method for virtual access. The method includes capturing, by a user equipment (UE), a first data, wherein the first data comprises at least one of raw data, sensor data, temperature data, pressure data, camera sensor data, light intensity data, time data, location data, dew point data, seismic data, weather data, audio, video, and images, and accessing, by a second UE, the first data on the UE, wherein the second UE is a server. The method further includes representing, by the second UE, an existence of the first data within a virtual database. The method still further includes accessing, by a third UE, the first data on the second UE, wherein the accessing comprises receiving at least one of the first data, a portion of the first data, a proxy file of the first data, and a low resolution version of the first data based on an application running on the third UE.

A second exemplary embodiment of the present disclosure provides an apparatus for virtual access, the apparatus comprising at least one processor and a memory storing computer instructions executable by at least one processor, wherein the memory and the computer instructions and the at least one processor are configured to cause the apparatus to at least receive a captured first data, wherein the first data comprises at least one of raw data, sensor data, temperature data, pressure data, camera sensor data, light intensity data, time data, location data, dew point data, seismic data, weather data, audio, video, and images. The at least one processor with the memory including computer instructions are further configured to cause the apparatus to at least represent an existence of the first data within a virtual database, and transmit the first data to a user equipment (UE), wherein the transmitting comprises transmitting at least one of the first data, metadata of the first data, a portion of the first data, a proxy file of the first data, and a low resolution version of the first data based on an application running on the UE.

A third exemplary embodiment of the present disclosure provides a non-transitory computer-readable medium tangibly storing computer program instructions which when executed by a processor, cause the processor to at least receive a captured first data, wherein the first data comprises at least one of raw data, sensor data, temperature data, pressure data, camera sensor data, light intensity data, time data, location data, dew point data, seismic data, weather data, audio, video, and images. The non-transitory computer-readable medium with the computer program instructions is further configured to cause the processor to represent an existence of the first data within a virtual database, and transmit the first data to a user equipment (UE), wherein the transmitting comprises transmitting at least one of the first data, a portion of the first data, metadata of the first data, a proxy file of the first data, and a low resolution version of the first data based on an application running on the UE.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 presents an exemplary device suitable for use in performing exemplary embodiments of the present disclosure.

FIG. 2 presents an exemplary signaling diagram suitable for use in performing exemplary embodiments of the present disclosure.

FIG. 3 presents another signaling diagram suitable for use in performing exemplary embodiments of the present disclosure.

FIG. 4 presents the operation of an exemplary device suitable for use in performing exemplary embodiments of the present disclosure.

FIG. 5 presents a logic flow diagram in accordance with a method and apparatus for performing exemplary embodiments of the present disclosure.

### DETAILED DESCRIPTION OF THE INVENTION

Embodiments of the present disclosure provide a method, apparatus and computer readable medium that allows a user to capture, transfer and/or copy a media file, raw data, sensor data, temperature data, pressure data, camera sensor data, light intensity data, time data, location data, dew point data, seismic data, weather data, and transfer that media file, raw data, sensor data, temperature data, pressure data, camera sensor data, light intensity data, time data, location data, dew point data, seismic data, weather data to a user equipment. It should be appreciated that transfer means transmitting the data over a bus connection or a network. Once the media file is located or downloaded on the user equipment such that all of the data that comprises the data is maintained or located on the memory of the user equipment, the system is operable to allow the captured media to be represented at a plurality of locations such that it can be accessed on the server. The media can then be automatically converted in response to how a third party device or user intends to use or manipulate the data.

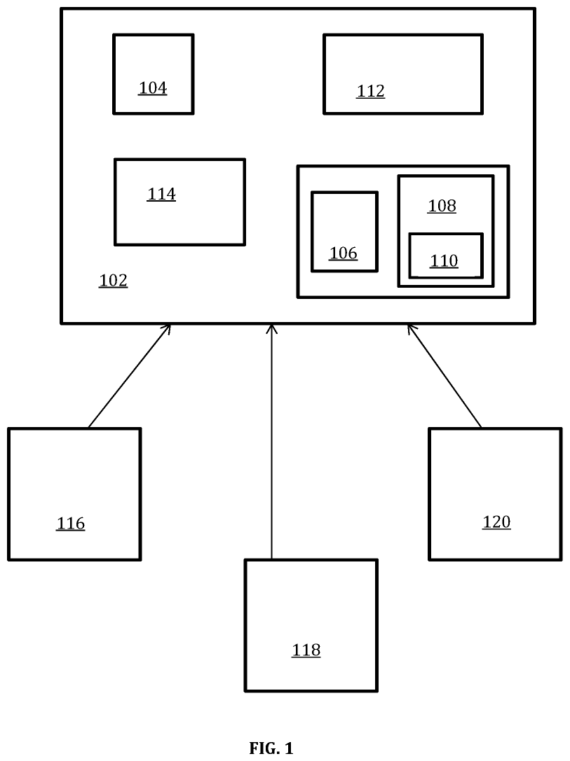

Referring to FIG. 1, shown is an exemplary device suitable for use in performing exemplary embodiments of the present disclosure. Depicted in FIG. 1 is data capture device 102 operable to capture at least one of raw data, sensor data, temperature data, pressure data, camera sensor data, light intensity data, time data, location data, dew point data, seismic data, weather data, camera data, photographs, video and audio. Media capture device 102 includes a media capture element 104, a processor 106, a memory 108 storing computer program instructions 110, a user interface 112, and a transmitter/receiver 114. Embodiments of media capture element 104 include an audio recording device, any type of sensor, a camera sensor, a video recording device, and/or a photograph recording device. Embodiments of media capture element include digital camera lenses, optical camera lenses, camera sensors, light sensors, sensors, atmospheric sensors, temperature sensors, pressure sensors, location sensors (e.g., GPS), seismic sensors, date/time sensors, audio listening elements and the like. Embodiments of media capture device 102 include cameras, digital cameras, digital video cameras, cell phones, mobile phones, smart phones, tablets, laptop computers, desktop computers, and the like. Embodiments of processor 106 include, but are not limited to general purpose computer processors, microprocessors, digital signal processors and multi-core processors.

Embodiments of memory 108 of media capture device 102 include persistent memory, which includes any type of memory known in the art that can continue to be accessed using memory instructions or memory application program interfaces even after the end of the process that created or last modified them. In another embodiment, memory 108 is volatile memory that is memory which requires power to maintain the stored information it retains in its contents while powered on, but when the power is interrupted the stored data is immediately lost. In yet another embodiment, memory 108 includes both volatile memory and persistent memory.

Embodiments of computer program instructions 110 include any type of program, application, computer instructions or program instructions that, when executed by processor 106, enable media capture device 102 to operate in accordance with embodiments of the present disclosure as detailed herein. Embodiments of user interface 112 are operable to allow a user to operate media capture device as described herein. Embodiments of user interface 112 can include a display and/or a speaker that is operable to receive user inputs and display outputs.

Embodiments of media capture device 102 is operable to send and/or transmit data via the transmitter/receiver 114 through wired or wireless connections. Embodiments of data include captured raw data, sensor data, temperature data, pressure data, camera sensor data, light intensity data, time data, location data, dew point data, seismic data, weather data, camera data, audio, video and/or photograph files. Embodiments of media capture device 102 are capable of wired or wireless bidirectional communication with other devices (e.g., servers, smartphones, computers, tablets, wearable devices, etc.) through transmitter/receiver 114, which includes a bus connection (e.g., USB, ethernet, firewire, lightning connector, USB-C, etc.). It should also be appreciated that transmitter/receiver 114 can include wireless connections (e.g., Bluetooth, WIFI, etc.). Media capture device 102 is able to communicate, directly or indirectly, through a network (e.g., a local area network (LAN), a wide area network (WAN), and/or a combination of both networks) such that media capture device 102 is operable to transmit or receive data including captured media to a server or other UEs. Embodiments of media capture device 102 through transmitter/receiver 114 are operable to communicate to global networks (e.g., the internet, etc.). It should be appreciated that transmitter/receiver 114 can include a bus or wired connection, a local wireless connection (e.g., a local network, local hotspot), and/or an internet connection. As shown in FIG. 1, media capture device 102 is operable to receive data (e.g., video, audio, and/or photographs) from a plurality of different sources. Embodiments of media capture device 102 include digital cameras, smart phones, tablets, laptop computers, desktop computers, smart watches, wearable devices and the like. As depicted in FIG. 1, media capture device 102 is operable to receive raw data, sensor data, temperature data, pressure data, camera sensor data, light intensity data, time data, location data, dew point data, seismic data, weather data, camera data, video data, audio data, and/or photographs 116, 118, 120. It should be appreciated that raw data, sensor data, temperature data, pressure data, camera sensor data, light intensity data, time data, location data, dew point data, seismic data, weather data, camera data, video data, audio data and photographs 116, 118, 120 are not separate and distinct from one another such that media capture device 102 can only receive one of these types of data at a time. Rather, embodiments of media capture device 102 are operable to receive one or all forms of data either one at a time or simultaneously.

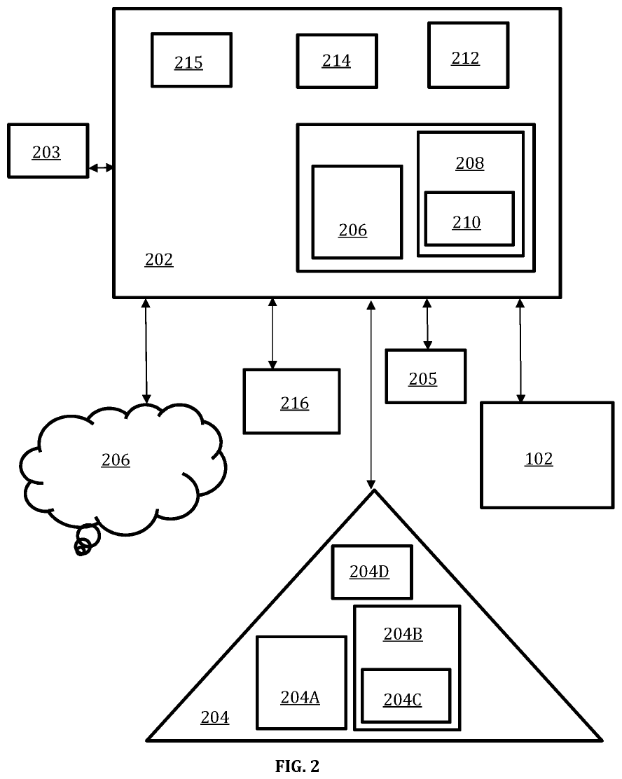

Referring to FIG. 2, shown is an exemplary signaling diagram suitable for use in performing exemplary embodiments of the present disclosure. Shown in FIG. 2 is user equipment (UE) 202 operable for bidirectional communication with media capture device 102, media storage device 204, local server 205, and cloud server 206. Embodiments of UE 202 are operable to send and receive data with media capture device 102, media storage device 204, and/or cloud server 206. It should be appreciated that embodiments of bidirectional communication include the transfer of data through an optional memory device 203 (e.g., memory stick, SD card, memory card, USB memory drive, etc.) that is can be connected to media capture device 102, disconnected from media capture device 102, and connected to media storage device 204 and/or cloud server 206 such that data can be transferred to and from the memory device 203. Embodiments of data include raw data, sensor data, temperature data, pressure data, camera sensor data, light intensity data, time data, location data, dew point data, seismic data, weather data, camera data, video data, audio data, photographic data, metadata associated with a file, the presence, absence or existence of a file, file type, file size, date of file creation, date of file edits, or a combination of any of these. UE 202 includes a processor 206, a memory 208, computer program instructions 210, a user interface 212, transmitter/receiver 214, and power source 215. Embodiments of power source 215 include a battery maintained within UE 202 and can also include a wired connection to an outlet or other external power source.

Embodiments of processor 206 include general purpose computer processors, microprocessors, digital signal processors and multi-core processors. Embodiments of memory 208 include persistent memory, which includes any type of memory known in the art that can continue to be accessed using memory instructions or memory application program interfaces even after the end of the process that created or last modified them. In another embodiment, memory 208 is volatile memory that is memory which requires power to maintain the stored information it retains in its contents while powered on, but when the power is interrupted the stored data is immediately lost. In yet another embodiment, memory 208 includes both volatile memory and persistent memory. Various embodiments of memory 208 include any data storage technology type which is suitable to the local technical environment, including but not limited to semiconductor based memory devices, magnetic memory devices and systems, optical memory devices and systems, fixed memory, removable memory, disc memory, flash memory, read only memory (ROM), random access memory (RAM), programmable read-only memory (PROM), erasable programmable read only memory (PROM), dynamic random-access memory (DRAM), static random-access memory (SRAM), electrically erasable programmable read-only memory (EEPROM) and the like.

Embodiments of computer program instructions 210 include any type of program, application, computer instructions or program instructions that, when executed by processor 206, enable UE 202 to operate in accordance with embodiments of the present disclosure as detailed herein. Embodiments of user interface 212 are operable to allow a user to operate UE 202 as described herein. Embodiments of user interface 212 can include a display and/or a speaker that is operable to receive user inputs and display outputs. Embodiments of user interface 212 can include a touch screen display, a keyboard, a keypad, buttons and the like.

Embodiments of UE 202 are operable to send and/or transmit data via the transmitter/receiver 214 through wired or wireless connections. Embodiments of transmitter/receiver 214 are operable for bidirectional communication through a bus or wired connection (e.g., USB, ethernet, firewire, lightning connector, USB-C, etc.). Embodiments of transmitter/receiver 214 are also operable for bidirectional communication through a local wireless network connection (e.g., Bluetooth, WIFI, LAN, WAN, etc.). Embodiments of transmitter/receiver 214 are operable for bidirectional communication through a global network (e.g., the internet). It should be appreciated that transmitter/receiver 214 can include a bus or wired connection, a local wireless connection (e.g., a local network, local hotspot, etc.), and/or an internet connection (e.g., cellular network connection). Embodiments of data include captured raw data, sensor data, temperature data, pressure data, camera sensor data, light intensity data, time data, location data, dew point data, seismic data, weather data, camera data, audio, video and/or photograph files. Embodiments of UE 202 are capable of wired or wireless bidirectional communication with other devices (e.g., servers, internet, cloud devices, media capture device 102, media storage device 204, cloud server 206, etc.) through transmitter/receiver 214. UE 202 is able to receive data, directly or indirectly (e.g., internet, a local area network (LAN), a wide area network (WAN), and/or a combination of both networks) such that UE 202 is operable to transmit or receive data including captured media to other devices.

Embodiments of media storage device 204 include any type of storage device that is operable to maintain data. Embodiments of media storage device 204 include flash drives, hard drives, disc drives, smart phones, tablets, computers, laptops, wearable devices, smart watches and the like. Embodiments of media storage device 204 include a processor 204A, a memory 204B, computer program instructions 204C, a transmitter/receiver 204D and optionally a user interface 204E. It should be appreciated that embodiments of media storage device 204 can include simply a memory 204B, computer program instructions 204C and a transmitter/receiver 204D. Embodiments of transmitter/receiver 204D include any type of wired or wireless connection that can transfer data (e.g., Bluetooth, WIFI, ethernet, USB drive, Firewire, lightening connector, etc.) so that media storage device 204 can communicate with UE 202.

Cloud server 206 includes any type of server or cloud server that is known in the art. Embodiments of cloud server 206 include private servers, web servers, cloud servers, and/or commercial servers. Embodiments of cloud server 206 include one or multiple processors, memories, transmitters and receivers for transmitting and receiving data through wired or wireless connections. Exemplary embodiments of cloud server 206 include a single server or a plurality of servers. Embodiments of cloud server 206 can include servers that are publicly accessible or private servers that can only be accessed by a certain devices or entities that are authorized to connect to cloud server 206. Embodiments of cloud server 206 are able to communicate or transmit and receive data with UE 202.

UE 202 is operable for one way or bidirectional communication with media capture device 102, media storage device 204 and cloud server 206 such that UE 202 can send and receive data from media capture device 102, media storage device 204 and cloud server 206. UE 202 is also operable for one way or bidirectional communication with media capture device 102, media storage device 204 and cloud server 206 such that UE 202 can scan or determine the contents of the information and/or data stored on media capture device 102, media storage device 204 and cloud server 206. In this regard, UE 202 is operable to determine what data is maintained on media capture device 102, media storage device 204 and cloud server 206 without requiring the transfer of the actual data file from media capture device 102, media storage device 204 and cloud server 206. Upon scanning media capture device 102, media storage device 204 or cloud server 206, UE 202 is operable to compare the received information and/or data from the media capture device 102, media storage device 204 and cloud server 206 to the files, information, and/or data stored within the memory 208 of UE 202. This comparison can include files, information, and/or data stored in the persistent memory of UE 202 and/or the volatile memory of UE 202. Thus, UE 202 is operable to determine whether data on one of media capture device 102, media storage device 204 and cloud server 206 is also maintained within memory 208.

UE 202 is operable to have specific files, information and/or data stored in media capture device 102, media storage device 204 and/or cloud server 206 transferred to UE 202 based on whether those same files, information, and/or data are also maintained in memory 208. In other words, based on the comparison of data maintained on UE 202 and data maintained on media capture device 102, media storage device 204 and/or cloud server 206, UE 202 is operable to transfer or send files, information, and/or data to its memory 208 or from its memory 208 to at least one of media capture device 102, media storage device 204, and cloud server 206. This transfer can be automatic in response to the comparison or it can be in response to user inputs. Transfer in this particular context means that all of the data (rather than a portion of the data) is sent to and maintained on the memory 208 of UE 202. Embodiments of UE 202 provide that UE 202 can be controlled by the user interface 212 on UE 202, or by an application operating on another device that is operable to remotely control UE 202. For instance, embodiments of UE 202 can be controlled by an application running on a user equipment (UE) 216 (e.g., smart phone, tablet, etc.) that is operable through wired or wireless connection to UE 202 to control operation of UE 202. Embodiments of an application are operable to configure file system actions in an application, store in databases, and user/recall with the user interface 212 of UE 202. Embodiments of user interface 212 can include a display, a touch screen, a keypad, a keyboard, and/or the like that allow a user to control the operation of UE 202.

In practice, media capture device 102 will capture with media capture element 104 a data. The data can be raw data, sensor data, temperature data, pressure data, camera sensor data, light intensity data, time data, location data, dew point data, seismic data, weather data, camera data, audio, video and/or photograph files. Media capture device 102 will then send or transfer the data to UE 202 through transmitter/receiver 114 and transmitter/receiver 214. In other words, the transfer can be accomplished through wired (e.g., bus or other wired connection) or wireless communication means. In another embodiment, the captured data will be saved to memory device 203. In this embodiment, memory device 203 is operable to be connected and disconnected from media capture device 102, and connected and disconnected to UE 202 such the data can be transferred from memory device 203 to UE 202. It should be appreciated that the transfer from media capture device 102 to UE 202 can be performed while UE 202 is operating solely on battery power from power source 215, solely on power from an external power source, or a combination of both battery power and an external power source. It should also be appreciated that transfer here refers to sending the entire data to the UE 202 such that it is maintained in memory 208 of UE 202. It should also be appreciated that the data will be maintained in memory 208 that is persistent memory rather than volatile memory.

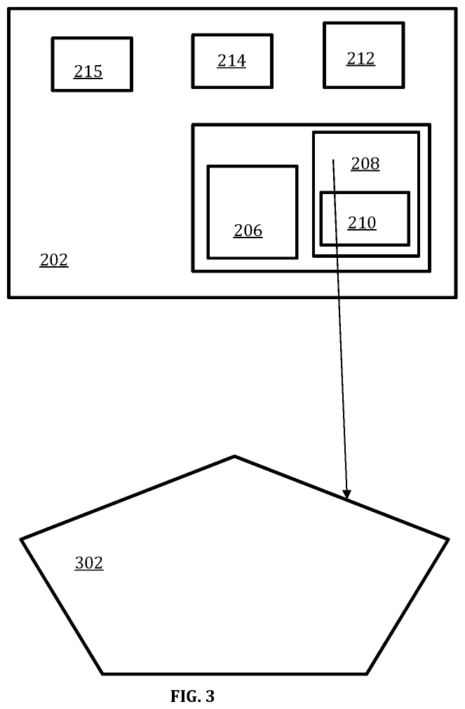

Reference is now made to FIG. 3, which depicts another signaling diagram suitable for use in performing exemplary embodiments of the present disclosure. Shown in FIG. 3 is UE 202 having a processor 206, a memory 208, computer program instructions 210, a user interface 212, transmitter/receiver 214, and power source 215. FIG. 3 also shows database 302. Database 302 is a virtual database maintained on UE 202 in memory 208. Embodiments of database 302 can be accessed by a plurality of third-party devices through wired or wireless connections (e.g., the internet, public or private networks). UE 202 is operable to maintain a plurality of data including data files in memory 208 and then prepare and/or convert the plurality of data from memory 208 such that it can be accessed in database 302. In this instance, the entire data of a file maintained in memory 208 is not prepared and/or converted for access on database 302. Rather, the data in memory 208 is prepared and/or converted such that it is represented to third-party devices or a plurality of devices who have access to database 302 as if the data is maintained on database 302 when in reality the data is still maintained on memory 208. The data maintained on memory 208 is prepared for database 302 by creating a variant call format, a proxy file, and/or a low resolution file for each data maintained on memory 208. Embodiments of a variant call format includes a text file that provides metadata that describes the data or file itself UE 202 will automatically or in response to user inputs on user interface 212 prepare the data maintained in memory 208 (memory 208 can be storage that is internal or external to the box) such that it can be viewed or accessed as a variant call format, a proxy file, and/or a low-resolution file on database 302. A proxy file means taking the data maintained on memory 208 and compressing the data to create a compressed data or proxy file. Compressing means encoding the data using fewer bits than the original data by identifying and removing redundancies in the data, which can include either lossy or lossless compression. A proxy file can also include metadata of the data or analyzed output of the raw data. Analyzed output Embodiments of metadata include information that (1) describes the data (e.g., title, abstract, author, and/or keywords), (2) describes containers of data and/or indicates how objects are put together (e.g., types, versions, relationship and/or other characteristics of digital materials), (3) describes the contents and quality of statistical data, and/or (4) describes processes that collect, process, or produce statistical data.

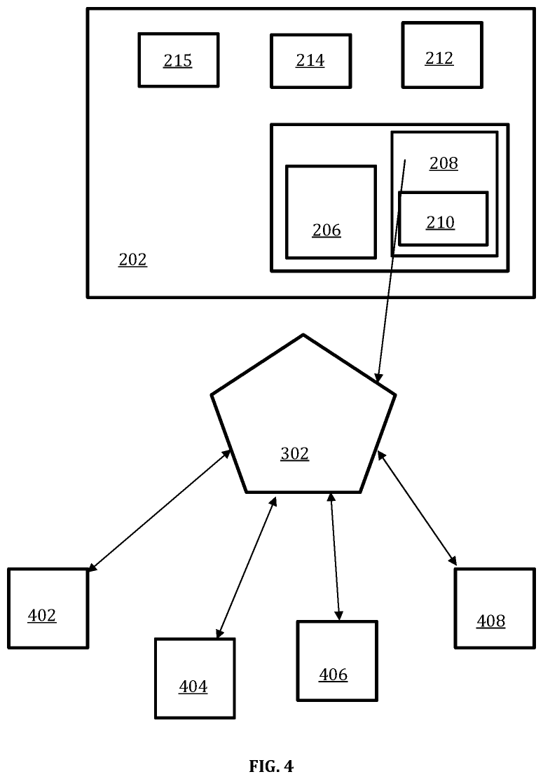

Reference is now made to FIG. 4, which illustrates the operation of an exemplary device suitable for use in performing exemplary embodiments of the present disclosure. Shown in FIG. 4 is UE 202 having a processor 206, memory 208, computer program instructions 210, user interface 212, and transmitter/receiver 214. Also shown in FIG. 4 is database 302. It should be appreciated that database 302 is a virtual database and is maintained on UE 202. FIG. 4 further includes cloud server 402, smart phone 404, tablet 406, and laptop 408. Cloud server 402, smart phone 404, tablet 406 and laptop 408 are each operable for bidirectional communication with UE 202 including database 302. UE 202 with database 302 is operable for bidirectional communication with a plurality of devices over a plurality of networks and the internet. It should be appreciated that while only cloud server 402, smart phone 404, tablet 406, and laptop 408 are depicted in FIG. 4, UE 202 with database 302 are operable to communicate with a plurality of devices including general purpose computers, desktop computers and other devices having a processor, a user interface, and is operable to communicate with other devices.

Embodiments of the present disclosure provide that UE 202 can maintain a particular file, information and/or data in a single location (e.g., memory 208). UE 202 is also operable to represent the presence of a particular file, information and/or data in one or more locations/devices (e.g., database 302) after preparing or creating a variant call format, a proxy file, and/or a low-resolution file. A low-resolution file means a version of the data having a lower pixel count from the original data. A low-resolution file can also mean a version of a file that is sufficiently high resolution for the end user or user to be able to discern a particular piece of information from the data while also being compressed to a smaller size in bytes than the original data or file. Representing the presence of a particular file, information and/or data means that a user or other device (e.g., cloud server 402, smart phone 404, tablet 406, and laptop 408) will be able to see the file, information and/or data on the one or more locations/devices (e.g., cloud server 402, smart phone 404, tablet 406, and laptop 408) as if the file, information and/or data is in fact located on the one or more locations/devices (i.e., database 302). However, the actual file, information and/or data will not be located on the one or more locations/devices. For instance, a user may be able to see on the user interface of smart phone 404, tablet 406, or laptop 408 that a particular file is located on database 302, however, the actual data and/or information will not be maintained on database 302. For example, the variant call format of the data will be on database 302. In this regard, memory 208 of UE 202 will be able to maintain a data while the data will appear to other users and/or devices that the data is also maintained in database 302.

Embodiments provide that cloud server 402, smart phone 404, tablet 406, and laptop 408 as well as any other devices that have access to database 302 will be able to access and/or download the data. Embodiments provide that cloud server 402, smart phone 404, tablet 406, and laptop 408 will be able to receive the entire data, a portion of the data, a low-resolution portion of the data and/or a version of the data in a different format. For instance, embodiments include UE 202 maintaining the data in one format and automatically converting the format of data into the format that cloud server 402, smart phone 404, tablet 406, and laptop 408 requires. In another embodiment, UE 202 will automatically recognize that cloud server 402, smart phone 404, tablet 406, and laptop 408 is accessing a data with a particular piece of software (e.g., adobe, final cut, etc.), but the data is in a different format than that piece of software. It should be appreciated that embodiments include cloud server 402, smart phone 404, tablet 406, or laptop 408 converting the data upon receipt by the application running on cloud server 402, smart phone 404, tablet 406, or laptop 408. In one embodiment, UE 202 will monitor the memory 208 for files and/or data this is added to UE 202. UE 202 is operable to create variants of files or data that are maintained or added to its memory 208. UE 202 can then update, represent or transfer all or portions of the data (including variants, metadata, etc.) to database 302 such that it can be accessed by other devices. Upon receipt of a request from a device (e.g., cloud server 402, smart phone 404, tablet 406, or laptop 408), UE 202 is operable to transmit database 302 information to the device. Upon transmitting all or a portion of the data, UE 202 will convert the data into the required format. In another embodiment, UE 202 (including an application running on UE 202 or a separate application) will recognize that cloud server 402, smart phone 404, tablet 406, or laptop 408 is only requesting access to a portion a particular piece of data. UE 202 will then transmit to cloud server 402, smart phone 404, tablet 406, or laptop 408 only the portion of the data required rather than the entire file. The data received from UE 202 can be maintained on cloud server 402, smart phone 404, tablet 406, or laptop 408 in volatile and/or non-volatile memory. Embodiments include the application running on UE 202 determining whether to maintain the received data in volatile and/or non-volatile memory based on the application used on cloud server 402, smart phone 404, tablet 406, or laptop 408, the size of the data, the available storage memory space available, and/or the expected use of the data by cloud server 402, smart phone 404, tablet 406, or laptop 408. In one embodiment, UE 202 will automatically determine whether to transfer the entire data file. Embodiments include UE 202 sending or transmitting data to smart phone 404, tablet 406, or laptop 408 through transmitter/receiver 214 via a wired or bus connection. In another embodiment, UE 202 is operable to send or transmit data to smart phone 404, tablet 406, or laptop 408 through wireless means, which can include Bluetooth, Wifi or a local network. Embodiments also include UE 202 being operable to send or transmit data to cloud server 402, smart phone 404, tablet 406, or laptop 408 via transmitter/receiver 214 through the internet. In another embodiment, the user requesting the data will be prompted with the option of the entire file, a portion of the file, a full resolution file, and/or a low resolution file.

Embodiments provide that cloud server 402, smart phone 404, tablet 406, or laptop 408 as well as a plurality of devices will be able to view and access data represented on database 302. UE 202 will transmit the requested data, a proxy file of the data, and/or a low-resolution version of the data to a plurality of devices (e.g., cloud server 402, smart phone 404, tablet 406, or laptop 408). Cloud server 402, smart phone 404, tablet 406, or laptop 408 will then be able to manipulate the data as desired (e.g., cut, crop, resize, clip, amend, etc.) and then will transmit those manipulations back to database 302 and UE 202. UE 202 will be able to compare the differences between the original data and the received manipulated data and amend the data based on the differences. In other words, embodiments include the user editing the data, the proxy file of the data or the low-resolution version of the data by cloud server 402, smart phone 404, tablet 406, or laptop 408. Once the editing is complete, at some predetermined point during the editing, or in response to user inputs, the edited data, proxy file or low-resolution version of the data will be sent back to the location it was original sent from (i.e., cloud server 402, smart phone, tablet 406, or laptop 408).

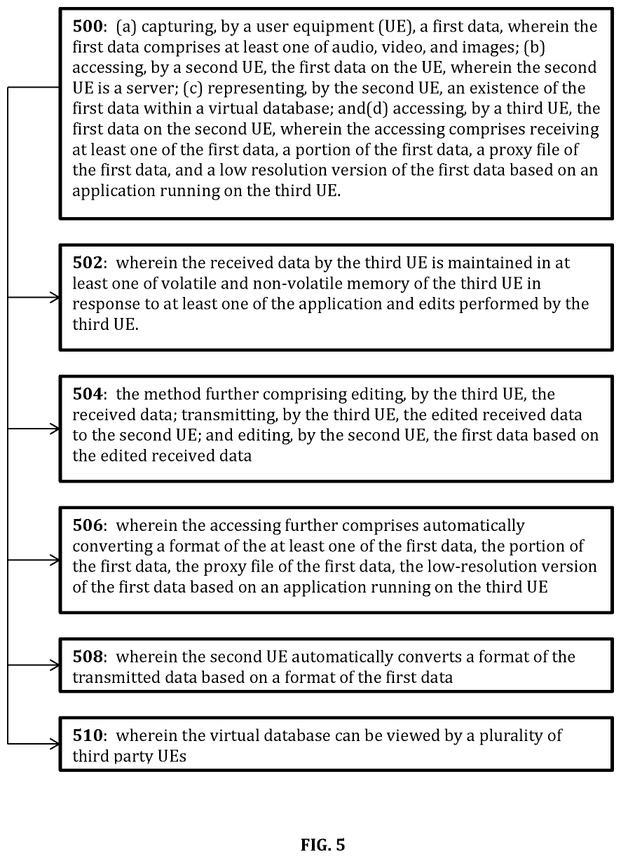

Reference is now made to FIG. 5, which presents an exemplary logic flow diagram in accordance with the above teachings. Block 500 presents (a) capturing, by a user equipment (UE), a first data, wherein the first data comprises at least one of audio, video, and images; (b) accessing, by a second UE, the first data on the UE, wherein the second UE is a server; (c) representing, by the second UE, an existence of the first data within a virtual database; and (d) accessing, by a third UE, the first data on the second UE, wherein the accessing comprises receiving at least one of the first data, a portion of the first data, a proxy file of the first data, and a low resolution version of the first data based on an application running on the third UE. Then block 502 specifies wherein the received data by the third UE is maintained in at least one of volatile and non-volatile memory of the third UE in response to at least one of the application and edits performed by the third UE.

Some of the non-limiting implementations detailed above are also summarized at FIG. 5 following block 502. Block 504 relates to the method further comprising editing, by the third UE, the received data; transmitting, by the third UE, the edited received data to the second UE; and editing, by the second UE, the first data based on the edited received data. Block 506 states wherein the accessing further comprises automatically converting a format of the at least one of the first data, the portion of the first data, the proxy file of the first data, the low-resolution version of the first data based on an application running on the third UE. Next block 508 specifies wherein the second UE automatically converts a format of the transmitted data based on a format of the first data. Block 510 indicates wherein the virtual database can be viewed by a plurality of third party UEs.

The present system thus allows a user to capture a media file and transfer that media file to a server. Once the media file is located on the server, the system is operable to allow the captured media to be represented at a plurality of locations such that it can be accessed on the server.

The logic flow diagram of FIG. 5 may be considered to illustrate the operation of a method, the result of execution of computer program instructions stored in a computer-readable medium. The logic diagram of FIG. 5 may also be considered a specific manner in which components of the device are configured to cause that device to operate, whether such a device is a mobile phone, cell phone, smart phone, laptop, digital camera, server, cloud server, tablet, desktop or other electronic device, or one or more components thereof. The various blocks shown in FIG. 5 may also be considered as a plurality of coupled logic circuit elements constructed to carry out the associated function(s), or specific result of strings of computer program instructions or code stored in memory.

Various embodiments of computer-readable medium include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. Various embodiments of the processor include but are not limited to general purpose computers, special purpose computers, microprocessors digital signal processors and multi-core processors.

The logic diagram on FIG. 5 may be considered to illustrate the operation of a method. The logic diagram may also be considered a specific manner in which components of a device are configured to be provided, whether such a device is an apparatus, a trocar assembly, a vacuum source, or one or more components thereof.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

This disclosure has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for virtual access, the method comprising:
(a) capturing, by a user equipment (UE), a first data, wherein the first data comprises at least one of raw data, sensor data, temperature data, pressure data, camera sensor data, light intensity data, time data, location data, dew point data, seismic data, weather data, audio, video, and images;
(b) accessing, by a second UE, the first data on the UE, wherein the second UE is a server;
(c) representing, by the second UE, an existence of the first data within a virtual database; and
(d) accessing, by a third UE, the first data on the second UE, wherein the accessing comprises receiving at least one of the first data, a portion of the first data, a proxy file of the first data, and a low resolution version of the first data based on an application running on the third UE.

2. The method according to claim 1, wherein the received data by the third UE is maintained in at least one of volatile and non-volatile memory of the third UE in response to at least one of the application and edits performed by the third UE.

3. The method according to claim 1, the method further comprising editing, by the third UE, the received data;
transmitting, by the third UE, the edited received data to the second UE; and
editing, by the second UE, the first data based on the edited received data.

4. The method according to claim 1, wherein the accessing further comprises automatically converting a format of the at least one of the first data, the portion of the first data, the proxy file of the first data, the low-resolution version of the first data based on an application running on the third UE.

5. The method according to claim 3, wherein the second UE automatically converts a format of the transmitted data based on a format of the first data.

6. The method according to claim 1, wherein the virtual database can be viewed by a plurality of third party UEs.

7. An apparatus for virtual access, the apparatus comprising at least one processor and a memory storing computer instructions executable by at least one processor, wherein the memory and the computer instructions and the at least one processor are configured to cause the apparatus to at least:
(a) receive a captured first data, wherein the first data comprises at least one of raw data, sensor data, temperature data, pressure data, camera sensor data, light intensity data, time data, location data, dew point data, seismic data, weather data, audio, video, and images;
(b) represent an existence of the first data within a virtual database; and
(c) transmit the first data to a user equipment (UE), wherein the transmitting comprises transmitting at least one of the first data, metadata of the first data, a portion of the first data, a proxy file of the first data, and a low resolution version of the first data based on an application running on the UE.

8. The apparatus according to claim 7, wherein the transmitted first data is maintained in at least one of volatile and non-volatile memory of the UE in response to at least one of the application and edits performed by the UE.

9. The apparatus according to claim 7, the memory and the computer instructions and the at least one processor are further configured to cause the apparatus to at least receive an edited data, and edit the first data based on the edited received data.

10. The apparatus according to claim 7, the memory and the computer instructions and the at least one processor are further configured to cause the apparatus to at least automatically convert a format of the at least one for the first data, the portion of the first data, the proxy file of the first data, the low resolution version of the first data based on an application running on the UE.

11. The apparatus according to claim 9, wherein the receiving comprises the apparatus automatically converting a format of the edited received data based on a format of the first data.

12. The apparatus according to claim 9, wherein the apparatus receives the captured first data from at least one of a media capture device, a mass storage device, and a cloud server.

13. A non-transitory computer-readable medium tangibly storing computer program instructions which when executed by a processor, cause the processor to at least:
(a) receive a captured first data, wherein the first data comprises at least one of raw data, sensor data, temperature data, pressure data, camera sensor data, light intensity data, time data, location data, dew point data, seismic data, weather data, audio, video, and images;
(b) represent an existence of the first data within a virtual database; and
(c) transmit the first data to a user equipment (UE), wherein the transmitting comprises transmitting at least one of the first data, metadata of the first data, a portion of the first data, a proxy file of the first data, and a low resolution version of the first data based on an application running on the UE.

14. The non-transitory computer-readable medium according to claim 13, wherein the transmitted data is maintained in at least one of volatile and non-volatile memory of the UE in response to at least one of the application and edits performed by the UE.

15. The non-transitory computer-readable medium according to claim 13, the processor further caused to receive an edited data; and
edit the first data based on the edited received data.

16. The non-transitory computer-readable medium according to claim 13, the processor further caused to automatically convert a format of the at least one of the first data, the portion of the first data, the proxy file of the first data, the low resolution version of the first data based on an application running on the UE.

17. The non-transitory computer-readable medium according to claim 15, wherein the receiving comprises the apparatus automatically converting a format of the edited received data based on a format of the first data.

18. The non-transitory computer-readable medium according to claim 13, wherein the apparatus receives the captured first data from at least one of a media capture device, a mass storage device, and a cloud server.
